(19) United States
(12) Patent Application Publication
(10) Pub. No.: US 2012/0254789 A1
(43) Pub. Date: Oct. 4, 2012

(54) METHOD, APPARATUS AND COMPUTER PROGRAM PRODUCT FOR PROVIDING IMPROVED CLINICAL DOCUMENTATION

(75) Inventors: Kara Erlandsen, Marietta, GA (US); Apurva Sharma, Canton, GA (US)

(73) Assignee: McKesson Financial Holdings

(21) Appl. No.: 13/074,348

(22) Filed: Mar. 29, 2011

(51) Int. Cl. G06F 3/048

(52) U.S. Cl. 715/780

(57) ABSTRACT

A method for providing improved clinical documentation may include providing for display of an electronic medical chart having at least a notes entry section and a plurality of other chart sections associated with respective different healthcare related topics associated with a patient, displaying, in response to a user entry initiating a mode shift, a set of available data entry templates including a plurality of selectable data entry templates where each selectable data entry template includes a plurality of fields for entry of data corresponding to a topic associated with a corresponding one of the other chart sections, and utilizing data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates. A corresponding computer program product and apparatus are also provided.

### TECHNOLOGICAL FIELD

Embodiments of the present invention relate generally to solutions for providing clinical documentation regarding patient treatment and, more particularly, to a mechanism for providing improvements to the mechanisms by which clinical documentation is handled electronically.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to a physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, these applications are often very specific to certain organizations and to certain tasks. As such, certain functionalities or solutions may be tied to specific work environments.

One of the goals of instituting the EMR has been to allow accurate patient health records to be maintained in a manner that can be shared among the potentially many different healthcare providers that a patient may see over time. Thus, the goal of having a single health record that can be manipulated and shared wherever the patient chooses to go for treatment remains. However, despite having this goal in mind, software developers have taken different approaches to making entry of data into an EMR more automated. These different approaches can lead to complex data entry regimes that may somewhat complicate the use of EMRs rather than simplify their use as intended. Accordingly, it may be desirable to provide improvements to the manner in which clinical documentation is handled electronically.

### BRIEF SUMMARY

A method, apparatus and computer program product are therefore provided to enable the provision of clinical documentation electronically. For example, some embodiments may provide a mechanism by which a notes entry section of a medical chart may be used to propagate information to other chart sections. Accordingly, efficient entry of data for clinical documentation may be supported.

In one example embodiment, a method for providing clinical documentation is provided. The method may include providing for display of an electronic medical chart having at least a notes entry section and a plurality of other chart sections associated with respective different healthcare related topics associated with a patient; displaying, in response to a user entry initiating a mode shift, a set of available data entry templates including a plurality of selectable data entry templates where each selectable data entry template includes a plurality of fields for entry of data corresponding to a topic associated with a corresponding one of the other chart sections; and utilizing data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

In another example embodiment, a computer program product for providing clinical documentation is provided. The computer program product may include at least one computer-readable storage medium having computer-executable program code instructions stored therein. The computer-executable program code instructions may include program code instructions for providing for display of an electronic medical chart having at least a notes entry section and a plurality of other chart sections associated with respective different healthcare related topics associated with a patient; displaying, in response to a user entry initiating a mode shift, a set of available data entry templates including a plurality of selectable data entry templates where each selectable data entry template includes a plurality of fields for entry of data corresponding to a topic associated with a corresponding one of the other chart sections; and utilizing data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

In another example embodiment, an apparatus for providing clinical documentation is provided. The apparatus may include processing circuitry. The processing circuitry may be configured for providing for display of an electronic medical chart having at least a notes entry section and a plurality of other chart sections associated with respective different healthcare related topics associated with a patient; displaying, in response to a user entry initiating a mode shift, a set of available data entry templates including a plurality of selectable data entry templates where each selectable data entry template includes a plurality of fields for entry of data corresponding to a topic associated with a corresponding one of the other chart sections; and utilizing data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing electronic clinical documentation according to an example embodiment of the present invention;

FIG. 2 is a block diagram showing various components that may be included in an apparatus for providing electronic clinical documentation according to an example embodiment of the present invention;

FIG. 3 illustrates an example of a chart for a sample patient to support a description of one example embodiment;

FIG. 4 illustrates an example data entry template for entry of information related to patient vitals according to an example embodiment of the present invention;

FIG. 5 illustrates an example vitals chart section after having data entered therein by a data propagator according to an example embodiment of the present invention; and

FIG. 6 is a block diagram according to an example method for providing electronic clinical documentation according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, many different approaches are being taken to improving EMR data entry. Generally speaking, example embodiments of the present invention may facilitate the elimination of duplicate effort in relation to activities that may be associated with various entries in an electronic medical record or chart. While some solutions for eliminating such redundancies have been previously proposed, these solutions have required users to memorize specific data entry patterns or codes so that the data entered according to the patterns in a notes section can be used to populate other chart sections. The requirement for users to memorize the specific data entry patterns or codes can result in unwanted complication for users attempting to learn data entry formats, and can also facilitate propagation of erroneous entries in situations where the data entry patterns or codes are forgotten or a simple mistake is made in following the prescribed patterns. In some cases, if the correct pattern is not followed or the correct code is not remembered, the data propagation function may simply not work.

Some example embodiments of the present invention may enable users to utilize a notes page of an EMR in order to input data that can then be used to populate other chart sections automatically. This can eliminate redundancy and therefore improve efficiency. However, example embodiments may facilitate the automated propagation of data from the notes page to other appropriate chart sections without a requirement for the user to learn a complicated data entry pattern or coding scheme. Instead, some example embodiments may enable the user to request, from the notes page, a set of available data entry templates that enable the user to enter data, via a selected template, into the notes page and also have the data propagated to its respective other chart sections. The set of available data entry templates may be provided responsive to a user entry initiating a mode shift (e.g., via a specific unlock request, key entry or key combination). The set of available data entry templates may be provided in a drop down menu from which the user can select a specific control console or popup window to be displayed providing the corresponding selected data entry template. Each data entry template may provide the fields for data entry with corresponding identifiers for each respective field so that the user does not need to remember any formats or patterns. Instead, the format is provided by the respective data entry template.

Providing for entry of data into the fields of the data entry template enables the notes page to be filled in with free text and, upon selection of an option to display the set of available data entry templates, enables a mechanism to be provided to simultaneously fill in the notes page with clinical documentation data and fill in another portion of the chart with the same data that is filled into the notes page. When one of the data entry templates is selected, specific data may be entered into the fields of the data entry template to fill the notes page and also be propagated to a corresponding other portion of the chart that is tied to the selected data entry template. The fields of the data entry template can also be validated and/or range checked to facilitate quality control measures with respect to the data being entered. Furthermore, some fields may be designated as required fields in order to ensure that minimum data requirements (and corresponding minimum clinical documentation requirements) are met when the patient visits a healthcare provider.

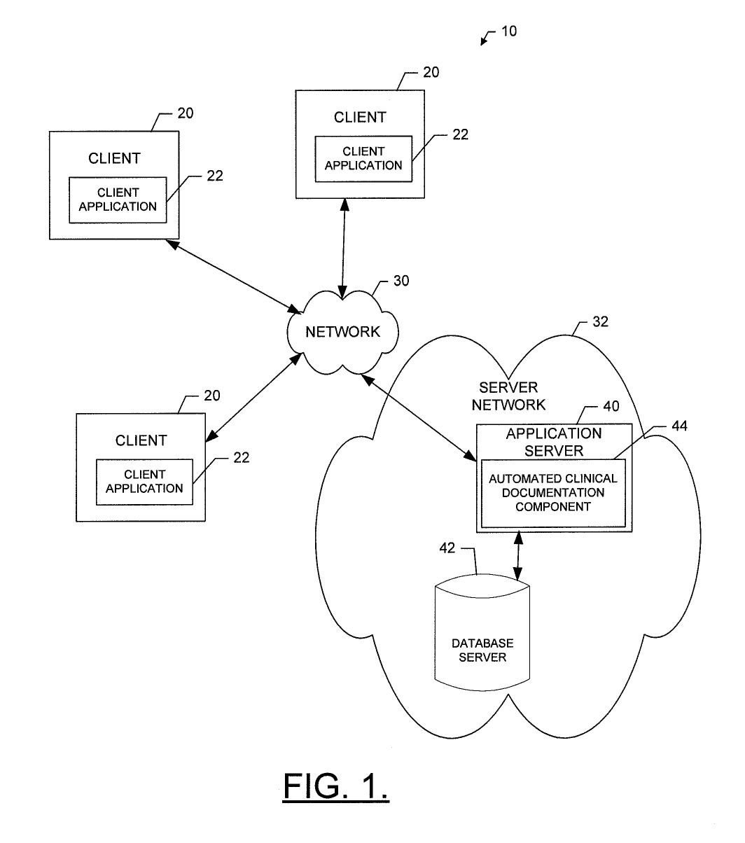

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, among the clients 20, one client may be associated with a first facility and a second client may be associated with a second facility. The facilities (and the corresponding clients) may be within the same healthcare organization or system or the facilities could be associated with different healthcare organizations or systems. As such, in some cases, multiple clients may be associated with the same organization.

Each one of the clients 20 may be, for example, a computer (e.g., a personal computer, laptop computer, network access terminal, or the like) or may be another form of computing device (e.g., a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving an automated clinical documentation component in the form of a deliverable component (e.g., as downloadable software to configure the client, or as a transferable memory device including instructions to configure the client). As such, for example, the client application 22 may include corresponding executable instructions for configuring the client 20 to provide corresponding functionalities as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of an automated clinical documentation component or the provision of services provided by an automated clinical documentation component of an example embodiment.

In some embodiments, for example, the application server 40 may therefore include an instance of an automated clinical documentation component 44 comprising stored instructions for handling activities associated with practicing example embodiments as described herein. As such, in some embodiments, the clients 20 may access the automated clinical documentation component 44 online and utilize the services provided thereby. However, it should be appreciated that in other embodiments, the automated clinical documentation component 44 may be provided from the application server 40 (e.g., via download over the network 30) to one or more of the clients 20 to enable recipient clients to instantiate an instance of the automated clinical documentation component 44 for local operation. As yet another example, the automated clinical documentation component 44 may be instantiated at one or more of the clients 20 responsive to downloading instructions from a removable or transferable memory device carrying instructions for instantiating the automated clinical documentation component 44 at the corresponding one or more of the clients 20. In such an example, the network 30 may not be needed or utilized at all.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the automated clinical documentation component 44 configured to operate in accordance with an example embodiment of the present invention. In this regard, for example, the automated clinical documentation component 44 may include software for enabling the application server 40 to communicate with the network 30 and/or the clients 20 for the provision and/or receipt of information associated with performing clinical documentation as described herein.

As such, the environment of FIG. 1 illustrates an example in which provision of selectably automated clinical documentation (e.g., in a healthcare record or EMR) may be accomplished by a particular entity (namely the automated clinical documentation component 44 residing at the application server 40). However, it should be noted again that the automated clinical documentation component 44 could alternatively handle provision of clinical documentation support within a single facility. Thus, in some embodiments, the automated clinical documentation component 44 may be embodied at one or more of the clients 20 and, in such an example, the automated clinical documentation component 44 may be configured to handle provision of selectably automated clinical documentation support only for the corresponding facility.

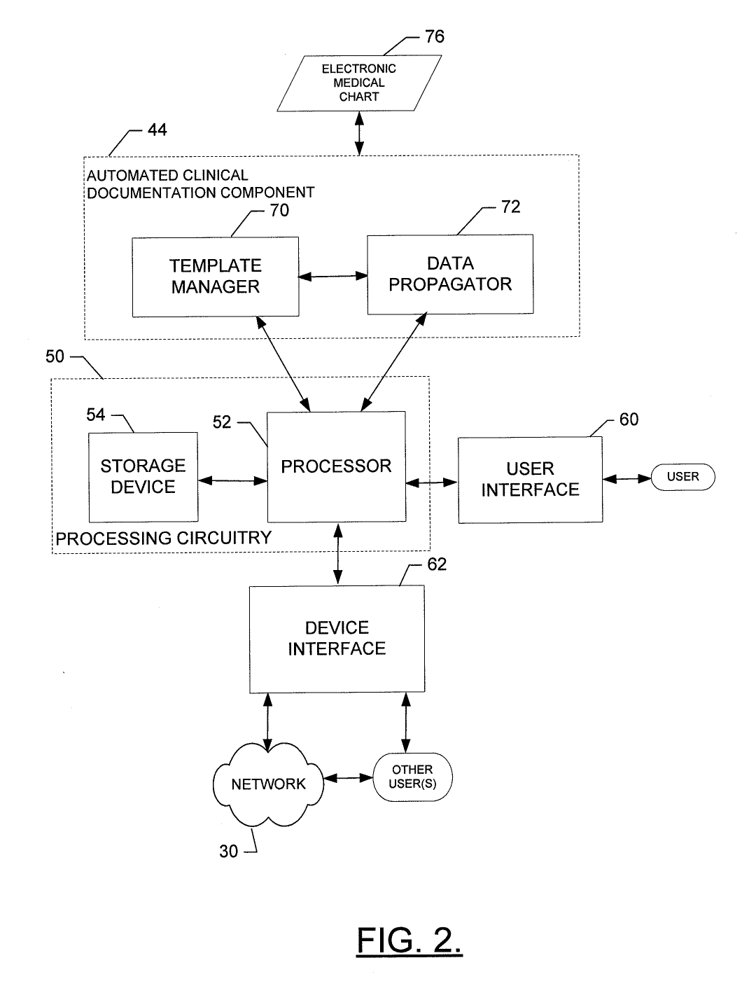

An example embodiment of the invention will now be described with reference to FIG. 2. FIG. 2 shows certain elements of an apparatus for provision of selectably automated clinical documentation support according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for provision of selectably automated clinical documentation support is provided. The apparatus may include or otherwise be in communication with processing circuitry 50 that is configured to perform data processing, application execution and other processing and management services according to an example embodiment of the present invention. In one embodiment, the processing circuitry 50 may include a processor 52 and a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non- transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or service application such as the automated clinical documentation component 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the automated clinical documentation component 44, which may include or otherwise control a template manager 70 and a data propagator 72. The template manager 70 and the data propagator 72 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the template manager 70 and the data propagator 72, respectively, as described below.

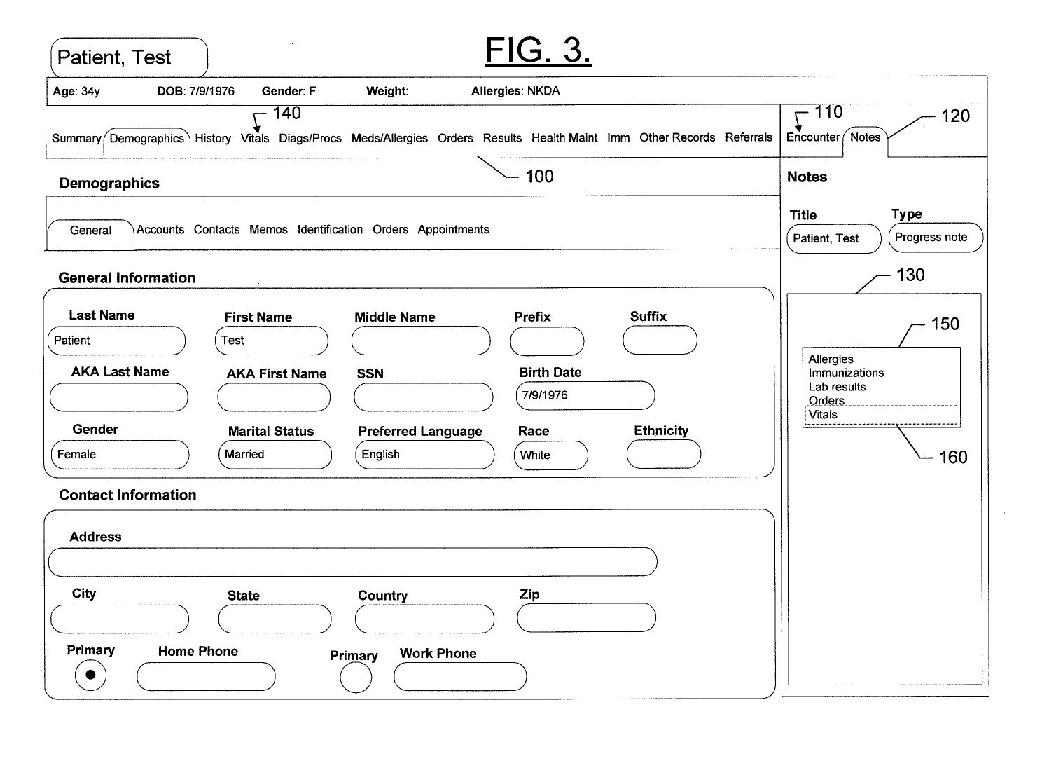

The automated clinical documentation component 44 may be a component of, or may itself be, a tool for managing EMRs or other electronic patient health records, generally referred to hereinafter as a chart (e.g., electronic medical chart 76). As such, the automated clinical documentation component 44 may be configured to provide an interface for inputting data, modifying data and/or saving data to charts associated with various different patients. The template manager 70 and the data propagator 72 may each interface with the chart to facilitate data entry into the chart. FIG. 3 illustrates an example of a chart for a sample patient (e.g., named Test Patient) that illustrates one example embodiment. As shown in FIG. 3, the chart may generally include a series of tabs 100 that each correspond to a respective different chart section. For example, separate tabs may be provided to enable viewing of chart sections devoted to summary information, demographic information, history information, vitals, diagnoses, medications and allergies, orders, results, health maintenance, immunizations, other records and referrals. In the example of FIG. 3, the demographics tab is selected and thus, demographic information associated with the sample patient is displayed. There may be further tabs and further data entry pages under each of the series of tabs 100.

Data may be entered and stored in association with the sample patient for any or all of the chart sections. When the sample patient is initially entered into the system, much of the demographic data, contact information, and other general data may be entered into the record to create the chart. Other data and chart sections will be filled in and utilized to store records of patient data for various visits or encounters that occur with the patient over time. However, when a patient is seen or receives treatment on any particular visit, only some of the data in any particular chart section may need to be modified to accommodate applicable changes and only some of the chart sections may be utilized to enter new data. To track the occurrences that are associated with any particular visit or encounter, an encounter details tab 110 may be provided. Meanwhile, in order to enable healthcare personnel to record notes regarding each encounter, a notes entry tab 120 may be provided.

The notes entry tab 120 may enable free text to be typed in to describe aspects of the interaction with the patient. Doctors are typically trained to record details of their patient interactions via notes. The notes entry tab 120 may provide access to a notes entry section 130 to enable the doctors to type in free text descriptive of the interaction. Since it is common for a patient making a doctor visit to see one or more other staff persons prior to seeing the doctor, and doctors often get preliminary information regarding the patient from the notes entry section 130 based on entries made by the staff persons, some of the preliminary information (e.g., patient vitals) may be entered into the notes entry section 130. It may be common practice for the notes entry section 130 to be left open when the doctor enters the exam room, so that the doctor can see what has been done already and also appreciate the results.

Selection of the notes entry tab 120 may result in the display of the notes entry section 130 and any text that has been recorded therein. Some of the information that may be recorded in the notes entry section 130 may also be data that is needed in one or more of the other chart sections. For example, as indicated above, information on the patient's vitals may be taken and recorded in the notes entry section 130, and that same information is also needed for entry into the chart section corresponding to patient vitals (e.g., tab 140). To provide an ability to have data recorded in the notes entry section 130 to be propagated also to the patient vitals chart section, the automated clinical documentation component 44 may be employed.

In this regard, the template manager 70 may be configured to provide a set of available data entry templates 150. The set of available data entry templates 150 may provide a listing of selectable data entry templates that may be used to populate both the notes entry section 130 and a corresponding other chart section (e.g., via the data propagator 72) with the data provided thereto. For example, selection of a vitals data entry template menu option 160 may result in the display of a data entry template in the form of a control console or popup window including fields for entry of vitals-related information. The data entry template may be configured to, when entry is completed and/or saved, close the data entry template, enter some or all of the data entered into the data entry template into the notes entry section 130 and also enter some or all of the data entered into a corresponding chart section.

In an example embodiment, the set of available data entry templates 150 may be displayed within the notes entry section 130 in response to a user entry initiating a mode shift. The user entry initiating the mode shift may be a specific request to unlock or display the set of available data entry templates 150 in the form of, for example, a key entry or key combination. In one example, simultaneous entry of two keys (e.g., Control and Space) may unlock or otherwise cause the display of the set of available data entry templates. In some cases, the user entry initiating the mode shift may be required to be entered in the notes entry section 130. The mode shift may enable “smart codes” to be used in connection with each respective data entry template to populate multiple chart sections via one data entry mechanism.

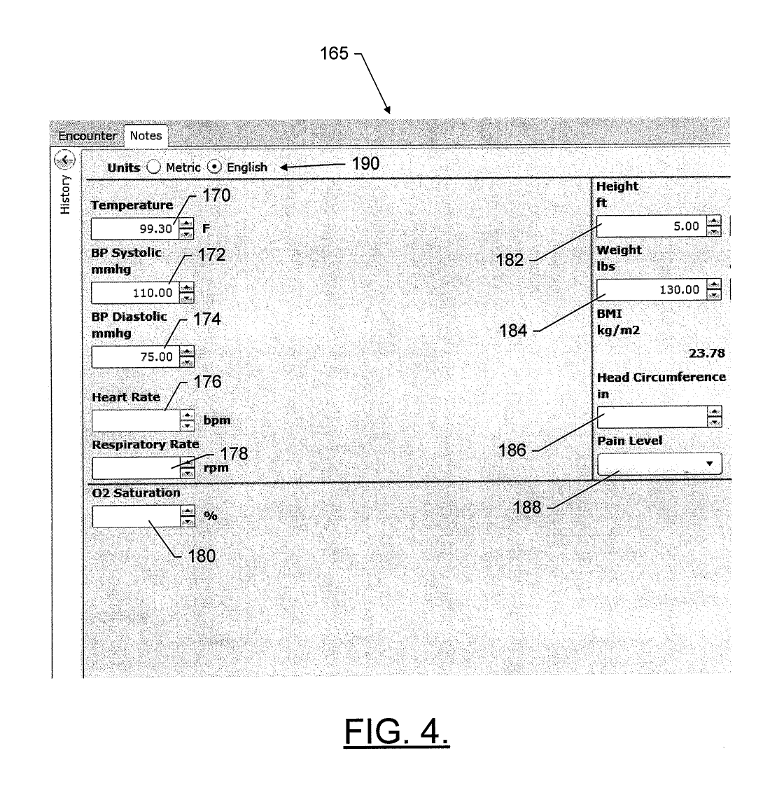

FIG. 4 illustrates an example data entry template for entry of information related to patient vitals. Each other data entry template menu option may also, when selected, link to a corresponding data entry template with fields tailored to receiving information associated with the corresponding topic. In an example embodiment, the data entry template of FIG. 4 may popup over all or a portion of the display of FIG. 3, or may replace the display of FIG. 3 when selected.

As shown in FIG. 4, a data entry template for vitals information 165 may include a plurality of fields (e.g., fields 170, 172, 174, 176, 178, 180, 182, 184, 186, and 188). Each of the fields may be titled appropriately in order to direct the user as to the information that is to be entered in each respective field. In some embodiments, certain information associated with a data entry template that is required to be entered, may be highlighted with a corresponding symbol (e.g., an asterisk) or with a colored border or other indicia. The user may be enabled to select each field (e.g., with a mouse or cursor) individually to enter data into the selected fields. However, in some embodiments, the user may be enabled to cycle forward and/or backward between fields to enter data into the selected fields. Data entry may be made, for example, by keyboard selection of characters, by selecting values from ranges of potential values that are provided to users in drop down selection blocks associated with various fields, or via inputting incremental variations from average expected inputs provided for various fields. In some embodiments, a conversion option 190 may also be provided to automatically convert values entered into a data entry template from one measurement standard to another (e.g., from metric to English units or vice versa).

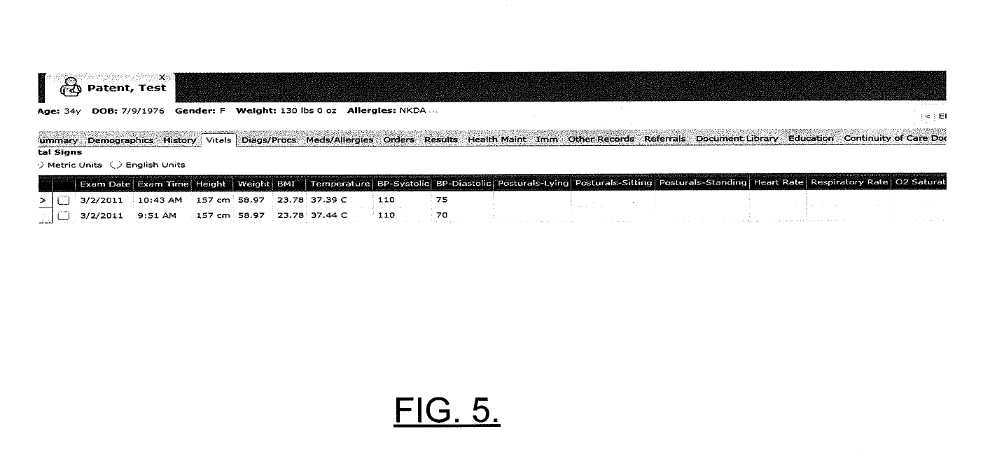

After data is entered into the fields of FIG. 4 and the data entry template is closed (e.g., by exiting or saving), the data entered into the fields of FIG. 4 may be propagated by the data propagator 72 into both the notes entry section 130 (e.g., as a notes entry) and a corresponding other chart section. The data propagator 72 may be configured to generate a notes entry tailored to the data that corresponds to each respective one of the data entry templates. Thus, for example, the data propagator 72 may utilize notes generation rules or templates that instruct the data propagator 72 as to how to generate a notes entry for each respective one of the data entry templates. As indicated above, the data from the fields may also be provided to another chart section. In this example, the data propagator 72 may fill the data entered into the fields of FIG. 4 into the vitals chart section, an example of which is shown in FIG. 5. FIG. 5 illustrates an example vitals chart section after having data entered therein by the data propagator 72 according to an example embodiment.

In some embodiments, one or more of the fields may include range limitations. For example, certain vital signs such as temperature are limited to a specific range for living humans. Values entered that are outside the specific range may be rejected or otherwise highlighted to alert the user that a value has been entered that falls outside of the range limitation for the corresponding value. In some cases, if a data entry template is filled out and includes data that is outside of the range limitation, the data entry template may not be able to be closed or saved until the value that is outside of the range limitation is corrected. Providing range limitations to the fields of certain data entry templates may improve accuracy of the information entered.

Accordingly, generally speaking, the template manager 70 of one example embodiment may be configured to provide a set of available data entry templates from which a user entering data into a notes entry section of a medical chart may select a data entry template. The data entry template may include a plurality of data fields and at least one of the data fields may be tied to both the notes entry section and another section of the chart. For example, the template manager 70 may include an association table or mapping of respective fields within each of the data entry templates and the corresponding chart sections to which data from the respective fields can be provided. The data propagator 72 may be configured to utilize the association table or mapping in order to send data from the data entry templates to the corresponding chart sections. As such, for example, when the data entry template is closed, the data propagator 72 may extract the data from each field that is to be used to populate chart sections and copy the extracted data to the appropriate portions or fields of both the notes entry section and at least one other section of the chart.

Thus, according to some example embodiments, the processing circuitry 50 may be configured to provide for display of an electronic medical chart having a notes entry section and a plurality of other chart sections associated with respective different healthcare related topics associated with a patient. In response to a user entry initiating a mode shift (e.g., via a key combination or other triggering input), a set of available data entry templates may be displayed. The set of available data entry templates may include a plurality of selectable data entry templates that may each include a plurality of fields for entry of data corresponding to a topic associated with a chart section. The processing circuitry 50 may further be configured to utilize data entered into at least one of the plurality of fields to provide a notes entry to the notes entry section and to fill chart data associated with at least one of the plurality of other chart sections in response to closing (e.g., via saving or exiting) a selected one of the selectable data entry templates after entry of data into one or more fields of the selected one of the selectable data entry templates.

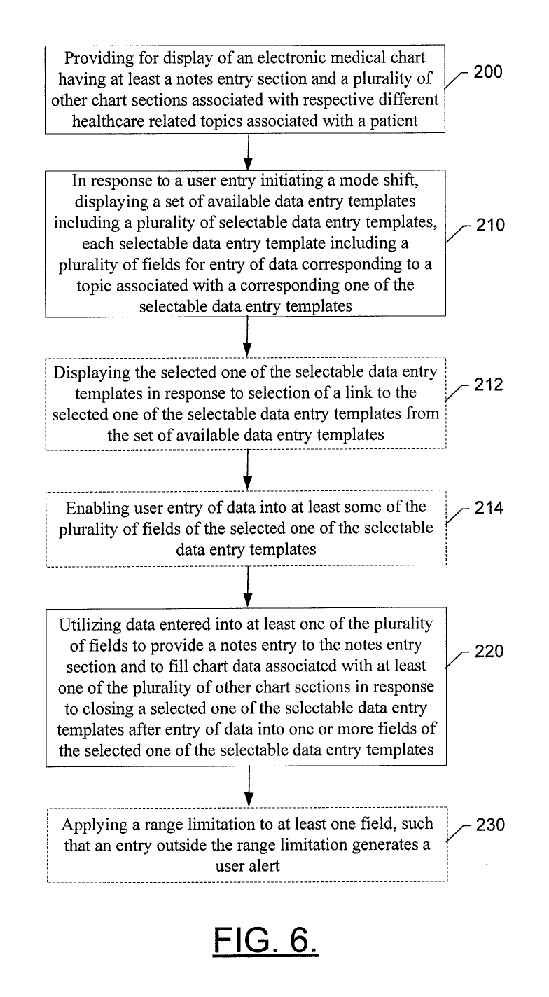

Embodiments of the present invention may therefore be practiced using an apparatus such as the one depicted in FIG. 2. However, other embodiments may be practiced in connection with a computer program product for performing embodiments of the present invention. FIG. 6 is a flowchart of a method and program product according to example embodiments of the invention. Each block or step of the flowchart of FIGS. 6, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer- implemented process such that the instructions which execute on the computer or other programmable apparatus provide operations for implementing the functions specified in the flowchart block(s).

In this regard, a method according to one embodiment of the invention, as shown in FIG. 6, may include providing for display of an electronic medical chart having at least a notes entry section and a plurality of other chart sections associated with respective different healthcare related topics associated with a patient at operation 200. The method may further include, in response to a user entry initiating a mode shift, displaying a set of available data entry templates including a plurality of selectable data entry templates at operation 210. Each selectable data entry template may include a plurality of fields for entry of data corresponding to a topic associated with a corresponding one of the selectable data entry templates. The method may further include utilizing (e.g., via processing circuitry) data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates at operation 220.

In some cases, the method may include additional optional operations (some examples of which are shown in dashed lines in FIG. 6). Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, the method may further include displaying the selected one of the selectable data entry templates in response to selection of a link to the selected one of the selectable data entry templates from the set of available data entry templates at operation 212 and enabling user entry of data into at least some of the plurality of fields of the selected one of the selectable data entry templates at operation 214. In some embodiments, the method may further include applying a range limitation to at least one field, such that an entry outside the range limitation generates a user alert at operation 230. In some cases, displaying the set of available data entry templates in response to the user entry may include displaying the set of available data entry templates in response to input of a specific key combination. In an example embodiment, displaying the set of available data entry templates in response to input of the specific key combination may include displaying the set of available data entry templates in response to input of the specific key combination in the notes entry section. In some embodiments, displaying the selected one of the selectable data entry templates may include displaying a conversion option selectable to automatically convert values entered into the selected one of the selectable data entry templates from one measurement standard to another measurement standard. In some situations, the notes entry section may be configured to receive free text input prior to initiating the mode shift and to display the set of available data entry templates subsequent to the mode shift. Other modifications are also possible. The modifications and optional operations may be included in any combination and in any order with respect to the operations 100-120 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of an electronic medical chart having at least a notes entry section and a plurality of other chart sections associated with respective different healthcare related topics associated with a patient;
in response to a user entry initiating a mode shift, displaying a set of available data entry templates including a plurality of selectable data entry templates, each selectable data entry template including a plurality of fields for entry of data corresponding to a topic associated with a corresponding one of the other chart sections; and
utilizing, via processing circuitry, data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

2. The method of claim 1, further comprising applying a range limitation to at least one field, such that an entry outside the range limitation generates a user alert.

3. The method of claim 1, wherein displaying the set of available data entry templates in response to the user entry comprises displaying the set of available data entry templates in response to input of a specific key combination.

4. The method of claim 3, wherein displaying the set of available data entry templates in response to input of the specific key combination further comprises displaying the set of available data entry templates in response to input of the specific key combination in the notes entry section.

5. The method of claim 1, further comprising:
displaying the selected one of the selectable data entry templates in response to selection of a link to the selected one of the selectable data entry templates from the set of available data entry templates; and
enabling user entry of data into at least some of the plurality of fields of the selected one of the selectable data entry templates.

6. The method of claim 1, wherein the notes entry section is configured to receive free text input prior to initiating the mode shift and to display the set of available data entry templates subsequent to the mode shift.

7. The method of claim 1, wherein displaying the selected one of the selectable data entry templates further comprises displaying a conversion option selectable to automatically convert values entered into the selected one of the selectable data entry templates from one measurement standard to another measurement standard.

8. An apparatus comprising processing circuitry configured to:
provide for display of an electronic medical chart having at least a notes entry section and a plurality of other chart sections associated with respective different healthcare related topics associated with a patient;
in response to a user entry initiating a mode shift, display a set of available data entry templates including a plurality of selectable data entry templates, each selectable data entry template including a plurality of fields for entry of data corresponding to a topic associated with a corresponding one of the other chart sections; and
utilize data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

9. The apparatus of claim 8, wherein the processing circuitry is further configured to apply a range limitation to at least one field, such that an entry outside the range limitation generates a user alert.

10. The apparatus of claim 8, wherein the processing circuitry being configured to display the set of available data entry templates in response to the user entry comprises the processing circuitry being configured to display the set of available data entry templates in response to input of a specific key combination.

11. The apparatus of claim 10, wherein the processing circuitry being configured to display the set of available data entry templates in response to input of the specific key combination comprises the processing circuitry being configured to display the set of available data entry templates in response to input of the specific key combination in the notes entry section.

12. The apparatus of claim 8, wherein the processing circuitry is further configured to:
display the selected one of the selectable data entry templates in response to selection of a link to the selected one of the selectable data entry templates from the set of available data entry templates; and
enable user entry of data into at least some of the plurality of fields of the selected one of the selectable data entry templates.

13. The apparatus of claim 8, wherein the notes entry section is configured to receive free text input prior to initiating the mode shift and to display the set of available data entry templates subsequent to the mode shift.

14. The method of claim 8, wherein the processing circuitry being configured to display the selected one of the selectable data entry templates comprises the processing circuitry being configured to display a conversion option selectable to automatically convert values entered into the selected one of the selectable data entry templates from one measurement standard to another measurement standard.

15. A computer program product comprising at least one computer-readable storage medium having computer-executable program code instructions stored therein, the computer-executable program code instructions comprising program code instructions for:
providing for display of an electronic medical chart having at least a notes entry section and a plurality of other chart sections associated with respective different healthcare related topics associated with a patient;
in response to a user entry initiating a mode shift, displaying a set of available data entry templates including a plurality of selectable data entry templates, each selectable data entry template including a plurality of fields for entry of data corresponding to a topic associated with a corresponding one of the other chart sections; and
utilizing data entered into at least one of the plurality of fields to provide a notes entry to the notes entry section and to fill chart data associated with at least one of the plurality of other chart sections in response to closing a selected one of the selectable data entry templates after entry of data into one or more fields of the selected one of the selectable data entry templates.

16. The computer program product of claim 15, further comprising program code instructions for applying a range limitation to at least one field, such that an entry outside the range limitation generates a user alert.

17. The computer program product of claim 15, wherein program code instructions for displaying the set of available data entry templates in response to the user entry include instructions for displaying the set of available data entry templates in response to input of a specific key combination.

18. The computer program product of claim 17, wherein program code instructions for displaying the set of available data entry templates in response to input of the specific key combination include instructions for displaying the set of available data entry templates in response to input of the specific key combination in the notes entry section.

19. The computer program product of claim 15, further comprising program code instructions for:
displaying the selected one of the selectable data entry templates in response to selection of a link to the selected one of the selectable data entry templates from the set of available data entry templates; and
enabling user entry of data into at least some of the plurality of fields of the selected one of the selectable data entry templates.

20. The computer program product of claim 15, wherein the notes entry section is configured to receive free text input prior to initiating the mode shift and to display the set of available data entry templates subsequent to the mode shift.

21. The computer program product of claim 15, wherein program code instructions for displaying the selected one of the selectable data entry templates include instructions for displaying a conversion option selectable to automatically convert values entered into the selected one of the selectable data entry templates from one measurement standard to another measurement standard.
